(19) United States
(12) Patent Application Publication
(10) Pub. No.: US 2016/0222928 A1
(43) Pub. Date: Aug. 4, 2016

(54) A MOTOR VEHICLE

(71) Applicant: UFI FILTERS S.P.A., PORTO MANTOVANO (IT)

(72) Inventor: Giorgio GIRONDI, MANTOVA (IT)

(73) Assignee: UFI FILTERS S.P.A., PORTO MANTOVANO (IT)

(21) Appl. No.: 14/916,673

(22) PCT Filed: Sep. 3, 2014
(86) PCT No.: PCT/IB2014/001718

§ 371 Date: Mar. 4, 2016

(30) Foreign Application Priority Data
Sep. 9, 2013 (IT) RE2013A000064

(51) Int. Cl. F02M 35/10; F02M 35/024; B60K 13/02

(52) U.S. Cl. CPC F02M 35/10144; B60K 13/02; F02M 35/024

(57) ABSTRACT

An embodiment of the present invention discloses a vehicle (100) comprising a bodywork (105), an internal combustion engine (140) and an aspirating conduit (175) able to convey air from an air intake (180) to the internal combustion engine, in which the air intake is positioned on a component (185) of the bodywork such as to offer at least an inlet opening (210) which opens externally of the bodywork (105), in a zone where aerodynamic effects due to motion of the vehicle (100) create an overpressure with respect to environmental atmospheric pressure.

### TECHNICAL FIELD

The present invention relates to the layout of a motor vehicle, and in particular the layout of a motor vehicle such as for example an automobile, a van or a truck.

### BACKGROUND ART

As is known, motor vehicles generally comprise a bodywork, i.e. a group of structural and/or covering components which define the external surfaces of the motor vehicle, internally of which are delimited the drive cabin and a multiplicity of compartments in which various devices and functional organs can be installed.

In particular, the front part of the bodywork generally delimits a large engine compartment which contains an internal combustion engine for propelling the motor vehicle, together with many other devices belonging to the auxiliary systems necessary for the functioning of the engine, among which an aspirating system of the comburent air.

The aspirating system generally comprises an aspirating conduit, defined by tracts of tube connected to one another by connectors and various accessories, which is able to place an air intake, i.e. a component for making available an inlet opening for the external air, in communication with an aspirating manifold associated to the internal combustion engine.

In this way, the air is aspirated internally of the aspirating system through the air intake and guided by the aspirating conduit towards the aspirating manifold, from which is it lastly conveyed internally of the cylinders.

A filter group is generally installed along the aspirating conduit, which normally comprises a closed casing provided with an inlet connected to the air intake and an outlet connected to the aspirating connector, and a filter cartridge provided with at least a wall made of porous material, which subdivides the internal volume of the casing into two separate chambers, of which a first chamber communicating with the outlet. In this way, the air flowing from the air intake towards the engine is forced to cross the wall made of porous material of the cartridge, which retains the dust particles and/or other impurities possibly present therein.

In the majority of motor vehicles at present known, the air intake of the aspirating system is positioned internally of the bodywork below the engine compartment bonnet and is connected to a calming chamber, which has the function of reducing the air turbulence and thus facilitates the aspiration by the engine.

A disadvantage of this solution is that it implicates that the volumetric efficiency of the engine, and therefore the developed power, are limited by the atmospheric pressure of the environment.

To go above this limit, an auxiliary boost system is known, typically a turbo-compressor, which has the function of increasing the air pressure in inlet to the engine, improving the filling of the cylinders.

These booster systems are however relatively expensive and involve considerable complications from both the constructional point of view and from that of management of the engine.

### DISCLOSURE OF THE INVENTION

An aim of the present invention is therefore to provide a solution which enables obviating or at least mitigating the above-mentioned drawbacks of the prior art.

A further aim is to achieve the above-mentioned objective with a solution that is simple, rational and relatively inexpensive.

These and other aims are attained with the characteristics of the invention that are reported in the independent claim. The dependent claims delineate preferred and/or especially advantageous aspects of the invention.

In particular, an embodiment of the present invention discloses a vehicle, typically a motor vehicle, which comprises a bodywork, an internal combustion engine and an aspirating conduit able to convey air from an air intake to the internal combustion engine, in which the air intake is positioned on a component of the bodywork such as to offer at least an inlet opening which opens externally of the bodywork, in a zone where aerodynamic effects due to motion of the vehicle create an overpressure with respect to environmental atmospheric pressure.

The advantages of this solution derive from the fact that the motion of the vehicle is such that it is constantly struck by an apparent air flow, the velocity of which is substantially equal and opposite the real velocity of a vehicle. When encountering the external surfaces of the bodywork of the vehicle, this apparent air flow is subject to deviations which induce variations of velocity in the air, which in turn cause, by aerodynamic effect, local pressure variations. Like aerodynamic effects are sometimes generated by the air currents induced by the final organs which enable the movement of the vehicle, in particular the rotation of the wheels.

By virtue of all these aerodynamic effects, it is therefore possible to identify zones adjacent to the vehicle in which during the movement of the vehicle the air pressure is greater than the ambient atmospheric pressure.

By locating the air intake in one of these zones, the engine is advantageously boosted in a substantially natural way, improving the volumetric efficiency without using any auxiliary boosting system.

In an aspect of the invention, the air intake can be positioned on a wheelhouse.

A wheelhouse is a component of the bodywork, having a generally arched shape, which delimits a compartment of the bodywork having the function of containing and covering one of the wheels of the vehicle.

As it is positioned in the wheelhouse, the air intake opens internally of the chamber, in which it has been found that the aerodynamic effects caused by the apparent air flow striking the vehicle, as well as those caused by the swirling air flow generated by the rapid rotation of the wheel, advantageously create a zone in which the air pressure is greater than ambient atmospheric pressure.

This positioning of the air intake is further advantageous as it contributes to reducing the volumes of the aspirating system of the vehicle, enabling a rationalization and optimization of the whole layout of the components internally of the engine chamber.

Internally of the wheelhouse, the air intake is more or less completely hidden from view, in order not to interfere with the overall aesthetic effect of the engine bodywork.

For these and other reasons, the solution of positioning the air intake on a wheelhouse might be advantageously adopted also in a case in which the relative inlet opening does not open into a booster zone.

In a further aspect of the invention, the aspirating conduit is intercepted by a filter group positioned internally of the bodywork, which comprises a containing casing provided with an inlet connected to the air intake and an outlet connected to the internal combustion engine, and a filter cartridge able to sub-divide the internal volume of the casing into a first chamber communicating with the inlet and a second chamber communicating with the outlet.

In this way, the particles of dust and/or other impurities present in the air flow in aspiration are advantageously retained by the filter cartridge, which prevents them from reaching the engine.

In an aspect of the invention, the filter cartridge comprises a plurality of filter walls having a tubular shape, which are configured so as to be crossed in parallel by the air to be filtered.

The solution is advantageous as the filter walls are singly smaller, and can be arranged between them in such a way as to occupy smaller spaces or in any case having more complex shapes, with respect to a single filter wall having an equal overall filtering capacity.

A further advantage of the solution is to reduce the noisiness caused by the air which is aspirated into the engine.

In a further aspect of the invention, the casing of the filter group is fixed to a wheelhouse preferably on the same wheelhouse on which the air intake can also be positioned.

With this solution, the filter group is located internally of the bodywork in a very peripheral position and normally not much used, thus freeing-up space in the centre of the engine compartment in which other accessory devices can be effectively housed.

In this way, it is also advantageously possible to realise, in a single structural component of the vehicle which incorporates the wheelhouse, the air intake and/or the casing of the filter group, which can be assembled separately and then installed on the vehicle as a single element, reducing and simplifying the mounting process.

In an aspect of the invention, at least a portion of the casing of the filter group is integrated in the wheelhouse, i.e. fashioned in a single body with the wheelhouse.

In this way the overall volume of the filter group can be further reduced, thus freeing up more space at the centre of the engine compartment of the vehicle.

The casing of the filter group can further comprise an openable cover for the extraction of the filter cartridge.

In this way it is advantageously possible to replace the filter cartridge when it is blocked.

In an aspect of the invention, the cover can be a removable portion of the wheelhouse.

With this solution, the cover can be removed from the outside of the bodywork, i.e. from the wheelhouse compartment, thus enabling the opening of the casing of the filter group, and thus the extraction and remounting of the filter cartridge in a simple and rapid way.

In a further aspect of the invention, the air intake comprises a tubular body located at an end of the aspirating conduit, which is provided with at least an inlet opening for air, and a hydrophobic net fixed to the tubular body, which intercepts the inlet hole.

In this way, the hydrophobic net prevents the particles of water possibly present in the air from entering the aspirating conduit and thus reaching the engine.

This solution is particularly useful for example in a case in which the air intake is positioned in the wheelhouse, because of the water which can be raised by the wheel if it is raining.

In a preferred aspect of the invention, the inlet opening is positioned on the lateral wall of the tubular body and in that the hydrophobic net is conformed as a sleeve that is coaxially inserted on the tubular body.

With this solution, the air crossing the inlet opening in a radial direction is forced to change direction so as to flow longitudinally towards the aspirating conduit.

This change of direction, together with the hydrophobic net located upstream, thus guarantees the complete separation of the water from the air before entering the aspirating conduit.

In a further aspect, the invention includes the possible presence of a helical body inserted internally of the tubular body downstream of the air inlet opening.

The helical body has the advantage of making the air flow uniform, thus reducing the turbulence thereof and therefore facilitating the aspiration of the engine.

### BRIEF DESCRIPTION OF THE DRAWINGS

Further characteristics and advantages of the invention will emerge from a reading of the following description provided by way of non-limiting example, with the aid of the figures illustrated in the appended tables.

FIG. 1 is a lateral view of a motor vehicle, the front part of which is partially sectioned according to plane I-I denoted in FIG. 2.

FIG. 2 is a plan view of the motor vehicle illustrated in FIG. 1, the front part of which is partially section so that some of the components located below the bonnet are visible.

FIG. 3 is a wheelhouse of the vehicle of FIG. 1, which is shown demounted, in larger scale and in perspective elevation according to the direction denoted generally by the arrow III of FIG. 2.

FIG. 4 is a perspective view of a filter cartridge contained in the filter group which is mounted on the wheelhouse of FIG. 3, shown in an even further enlarged scale.

FIG. 5 is a further perspective view of the wheelhouse, shown substantially from the opposite side with respect to the view of FIG. 3 and with the filter group uncovered.

FIG. 6 is a perspective view from below in an upwards direction of the wheelhouse of FIG. 5.

FIG. 7 is a perspective view in larger scale of the air intake connected to the filter group which is mounted on the wheelhouse.

FIG. 8 is section VIII-VIII of FIG. 7.

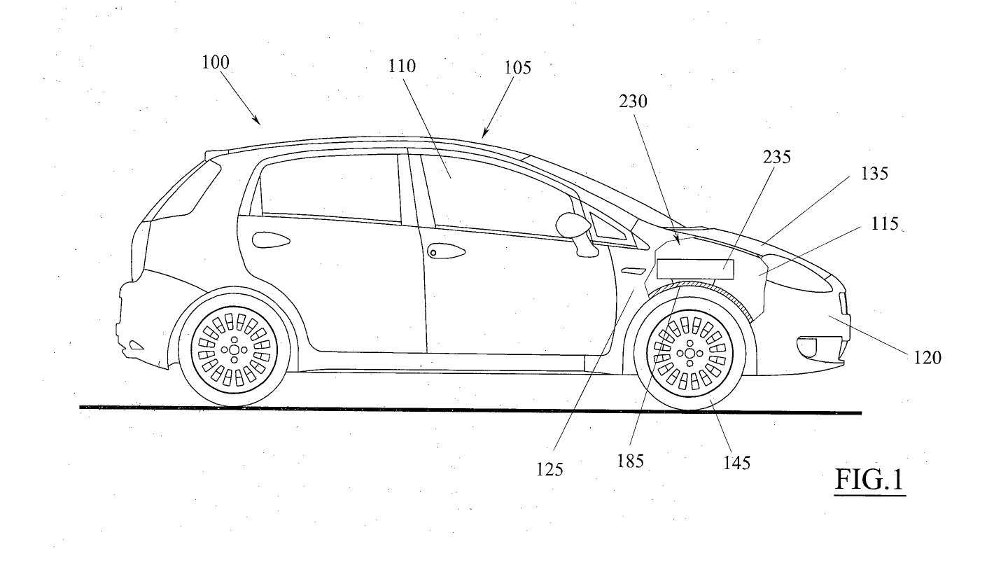

### BEST MODE FOR CARRYING OUT THE INVENTION

In the above-mentioned figures, reference number 100 generally indicates a motor vehicle.

The motor vehicle 100 comprises a bodywork 105, i.e. an assembly of structural elements and/or covering elements able to define the external surfaces and therefore the exterior shape of the motor vehicle 100.

The bodywork 105 internally delimits a multiplicity of empty spaces, among which in particular various loading compartments, a cabin 110 for accommodating the driver and any passengers, as well as a large engine compartment 115 arranged frontally with respect to the cabin 110.

In greater detail, the engine compartment 115 is perimetrally delimited by a front grille 120, two opposite lateral flanks 125 and 130, and a dashboard (not visible) which separates it from the cabin 110.

The engine compartment 115 is further superiorly closed by a bonnet 135, which can be opened to allow access to the inside.

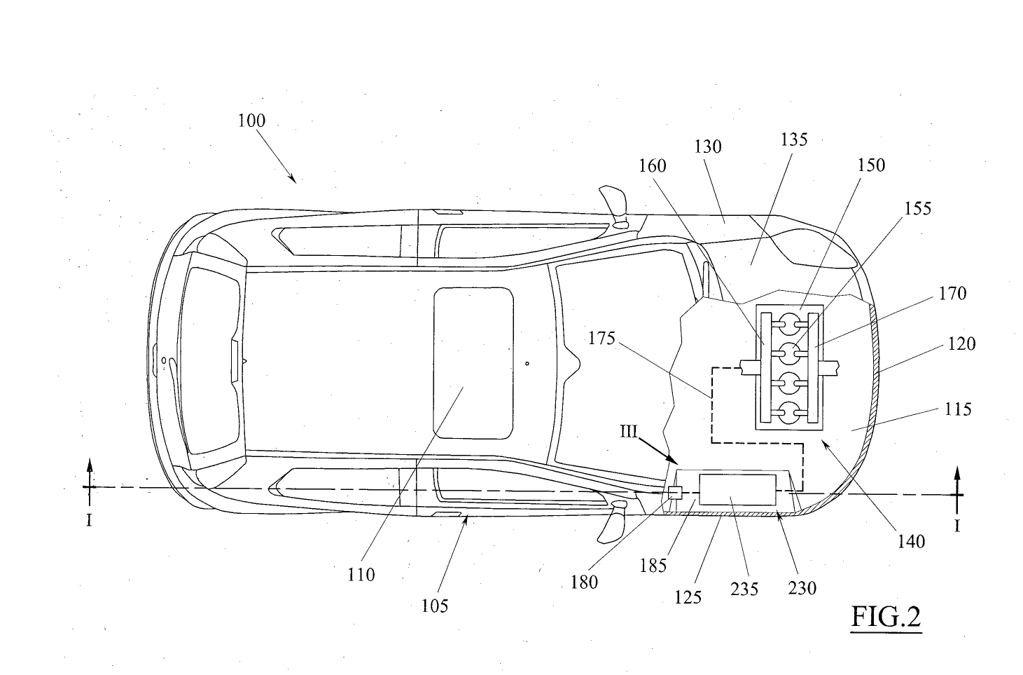

As illustrated in FIG. 2, the engine compartment 115 contains an internal combustion engine 140, for example a Diesel or petrol engine, for propelling the motor vehicle 100, in the example activating two front wheels 145 in rotation.

The engine 140 generally comprises a engine body 150 in which one or more cylinders 155 are fashioned, each of which houses a respective piston, which is coupled to a crankshaft housed in a lower block fixed below the engine body 150.

An air-fuel (for example diesel or petrol) mixture is supplied internally of the cylinders 155, the combustion of which produces hot gases which expand causing alternating motion of the pistons and therefore rotary motion of the crankshaft. The fuel can be supplied internally of each cylinder 155 by an injector (not illustrated) connected to a fuel tank via a pump. The comburent air can be supplied internally of each cylinder 155 via one or more aspirating openings, which are connected with an aspirating manifold 160 and are periodically opened and closed by respective aspirating valves (not illustrated). Likewise the combustion gases are discharged from each cylinder 155 via one or more discharge openings, which are connected to a discharge manifold 170 and are periodically opened and closed by respective discharge valves (not illustrated).

Normally, many other devices are internally housed of the engine compartment 115 belonging to the auxiliary systems necessary for the functioning of the engine 140, among which a lubrication system, a cooling system, a combustion gas treatment system exiting from the discharge manifold 170 as well as a system for conveying the comburent air internally of the aspirating manifold 160.

This comburent air conveyor system comprises an aspirating conduit 175 (indicated schematically with a broken line in FIG. 2), which is generally defined by one or more tracts of tube connected to one another by connectors and various accessories, and is overall aimed at connecting the aspirating manifold 160 with an air intake 180, i.e. a component for defining at least an inlet opening for the external air.

In an aspect of the invention, the air intake 180 is positioned on a component of the bodywork 105, in such a way that the at least an inlet opening opens, externally of the bodywork 105, into an overpressure zone.

An overpressure zone is a zone adjacent to the external surface of the bodywork 105, at which the aerodynamic effects due to the motion of the motor vehicle 100 are such that the air pressure is higher than the ambient atmospheric pressure.

These aerodynamic effects can be due to many concurrent factors, among which for example swirling air currents generated by the rapid rotation of the wheels and/or the apparent air flow which strikes the motor vehicle 100 and which is deviated by the external surfaces of the bodywork 105, thus being subjected to the local variations of velocity that in turn produce local pressure variations.

By positioning the air intake 180 in an overpressure zone, the effect of achieving a boost for the engine 140 is achieved, in a substantially natural way, improving the volumetric efficiency without using any auxiliary booster system.

In the illustrated embodiment, the air intake 180 is positioned on a wheelhouse 185, preferably a wheelhouse of one of the front wheels 145 of the motor vehicle 100.

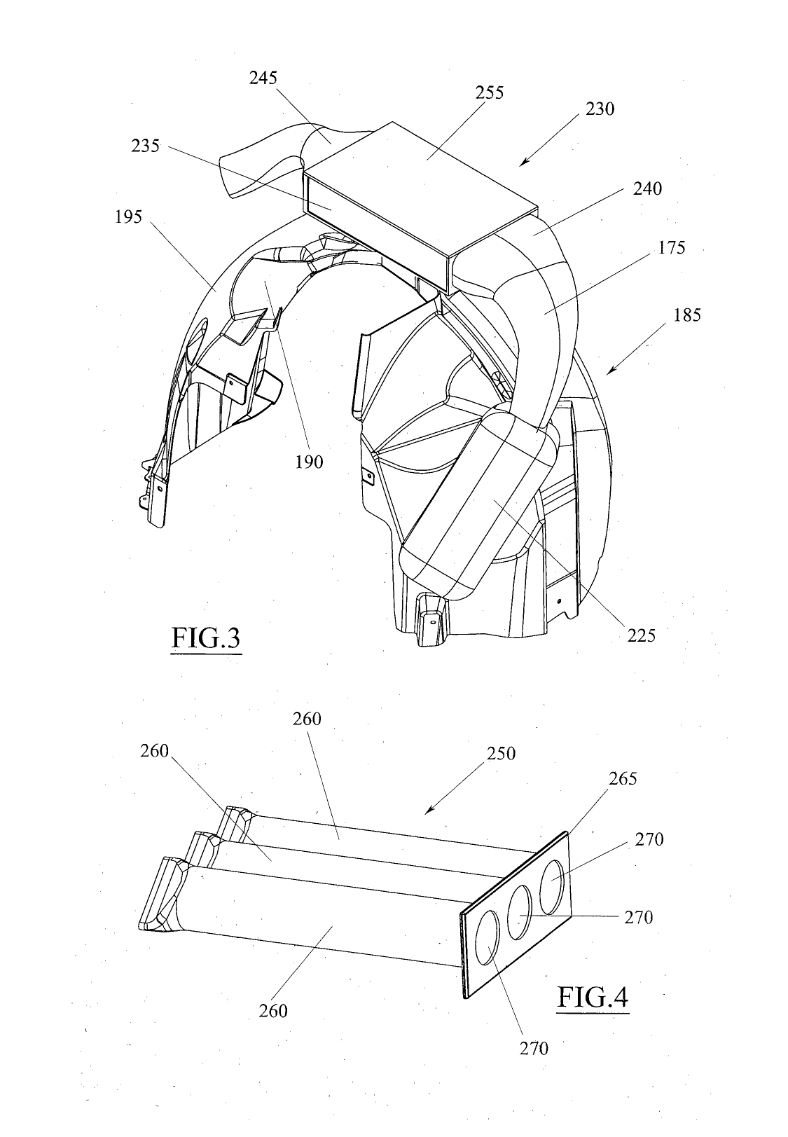

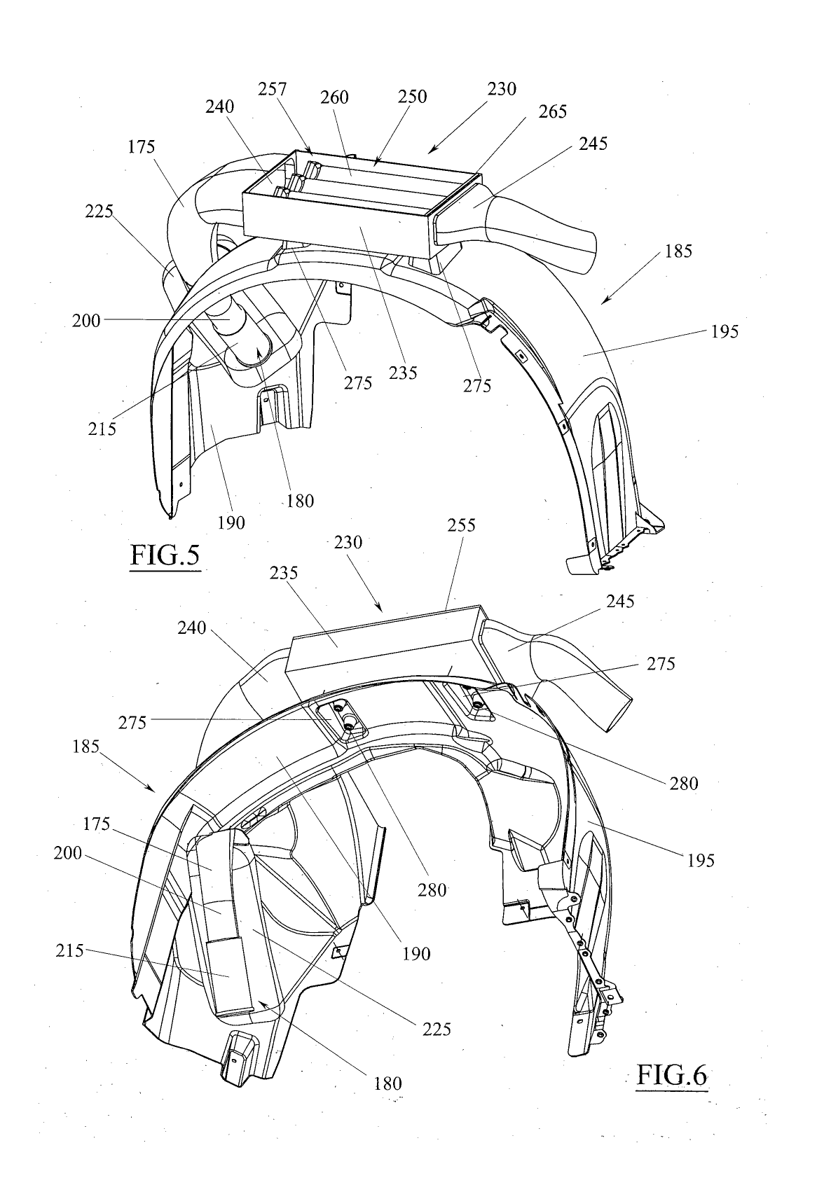

As shown in FIGS. 3, 5 and 6, the wheelhouse 185 is a concave component of the bodywork 105, the concavity of which is facing towards the outside of the bodywork 105 so as to define a recessed chamber which contains and covers one of the wheels of the motor vehicle 100, protecting it and also functioning as a mudguard. The wheelhouse 185 can be realised for example by a profiled body made of sheet metal or plastic, which comprises at least a strip which prevalently develops in an arc about the rotation axis of the relative wheel (at least when the motor vehicle 100 is moving in a straight line), such as to exhibit a concave internal surface 190 able to define a portion of the external surface of the bodywork 105 and facing radially towards the wheel, and an opposite convex surface 195 facing internally of the bodywork 105.

The air intake 180 is generally positioned at the arched strip of the wheelhouse 185, in such a way that the inlet opening thereof opens in a zone of the wheel chamber which is adjacent to the concave surface 190, where there is usually present an effective overpressure zone.

In this position, the air which is aspirated internally of the engine 140 might in any case transport a great quantity of water particles, especially if it is raining.

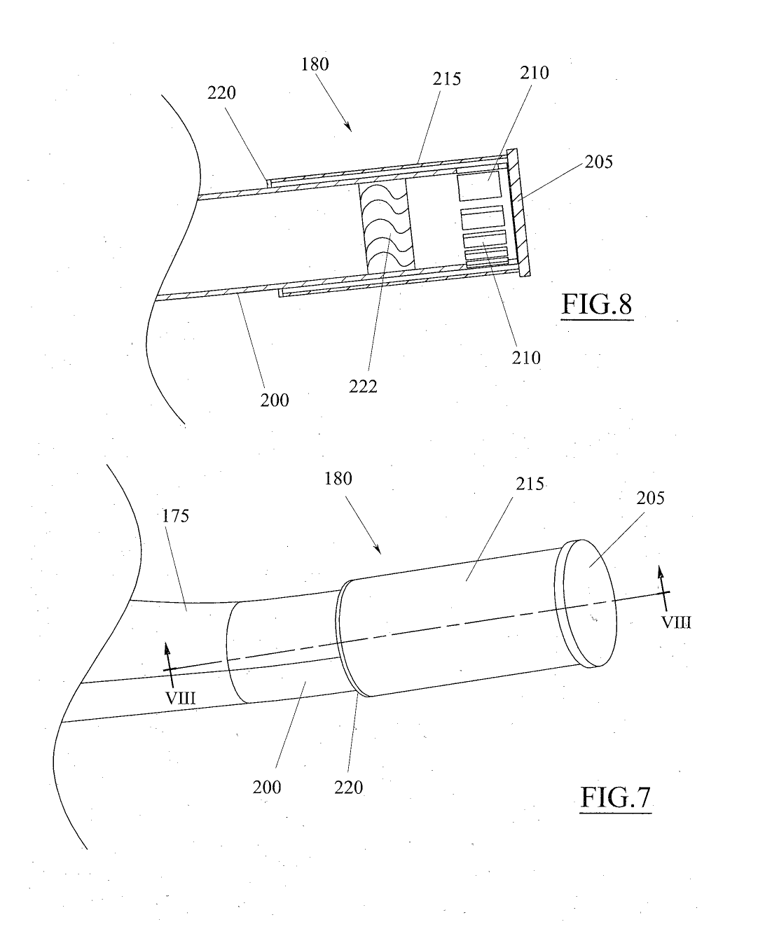

For this reason, the air intake, 180 can comprise a tubular body 200 (see FIGS. 7 and 8) having an end connected to the aspirating conduit 175 and an opposite end closed by a plate 205. A plurality of radial openings 210 can be afforded on the lateral surface of the tubular body 200, in proximity of the closing plate 205, each of which defines an inlet opening for the air.

The air intake 180 can further comprise a sleeve 215 made of hydrophobic netting, which is coaxially inserted on the tubular body 200, so as to intercept and cover the radial openings 210. The sleeve 215 can be fixed between the closing plate 205 and a support ring 220 inserted sealingly on the tubular body 200.

In this way, the air aspirated by the engine 140 is initially forced to cross the hydrophobic net sleeve, which separates and retains at least a first part of the water particles being transported.

After having crossed the sleeve 215, the air enters the tubular body 200 through the radial openings 210 and is then immediately forced to change direction so as to be able to flow longitudinally towards the aspirating conduit 175.

This sharp change of direction enables separating also the residual particles of water from the air, which particles may not have been blocked by the net, and preventing them from reaching the engine 140.

An impeller 222 can also be coaxially inserted along the tubular body 200, downstream of the radial openings 210, the function of which impeller 222 is to make the air flow uniform by reducing the turbulence thereof and therefore facilitating the aspiration of the engine 140.

In the illustrated example, the air intake 180 is preferably housed in a recessed niche 225, which is fashioned in the internal surface 190 of the wheelhouse 185, such as to have the concavity thereof facing towards the wheel chamber. The niche 225 can be made by specially shaping the profiled body of the metal or plastic sheet which defines the wheelhouse 185, and can comprise an opening through which the aspirating conduit 175 enters into the bodywork 105 of the motor vehicle 100 so as to reach the engine 140.

Internally of the bodywork 105 the aspirating conduit 175 can be intercepted by a filter group, denoted in its entirety by 230, which comprises a containing casing 235 provided with an inlet 240 connected with the air intake 180 and an outlet 245 connected to the internal combustion engine 140, and a filter cartridge 250, which is contained in the casing 235.

In the illustrated example, the casing 235 is conformed as a rather wide and slim box body, which exhibits six flat faces, of which two opposite larger faces, respectively upper and lower, and four lateral surfaces reciprocally opposite, two by two. The inlet 240 and the outlet 245 are fashioned on two opposite lateral faces, in such a way as to be substantially aligned.

The casing 235 can further comprise an openable cover 255 for inserting and extracted the filter cartridge 250, i.e. a cover able to close an opening 257 through which access is gained to internally of the casing 235 and through which the filter cartridge 250 can be passed. In the illustrated embodiment, the openable cover 255 can close, for example, the whole upper flank of the casing 235.

As illustrated in FIG. 4, the filter cartridge 250 can comprise a plurality of tubular filter walls 260 arranged parallel to one another, flanked and coplanar.

The tubular filter walls 260 are generally made of a porous material, for example of a non-woven textile made of polymer fibres, such a polypropylene fibres, which can be obtained by any known process, preferably a melt-blown process.

In the illustrated example, each filter wall 260 exhibits an open end and an opposite closed end.

The closed ends can be obtained by locally crushing the lateral wall of each tubular filter wall 260, such as to flatten and bring two opposite portions of the wall into reciprocal contact. These portions can then be joined to one another, for example by gluing or hot-welding, i.e. by at least partial fusion of the material of the wall, pressure and subsequent solidification. Alternatively, each tubular filter wall 260 might be directly realized in the form of a recipient closed at the bottom.

The open ends of the tubular filter walls 260 are fixed to a single support flange 265, which comprises a plurality of through-holes 270, each aligned to a respective tubular filter wall 260.

The fastening to the support flange 265 can be obtained for example by gluing, hot-welding or by means of a reversible joint fitting.

As illustrated in FIG. 5, the filter cartridge 250 is inserted in the casing 235 such that the tubular filter walls 260 are substantially aligned with the inlet 240 and outlet 245 and lie coplanarly on a parallel plane to the lower face of the casing 235.

The support flange 265 is fixed and sealed against the flank of the casing 235 in which the outlet 245 is afforded, so that it is in communication with the through-holes 270.

In this way, the filter cartridge 250 sub-divides the internal volumes of the casing 235 into two separate chambers, of which a chamber defined between the external surface of the filter walls 260 and the internal surface of the casing 235, which is in communication with the inlet 240, and a chamber defined internally of the filter walls 260, which is in communication with the outlet 245.

Thanks to this solution, the air which flows from the inlet 240 to the outlet 245 of the filter group 230 is forced to cross the filter walls 260 in parallel, which are thus able to retain the dust particles and/or other impurities that might be present in the air flow.

As regards the system layout, the casing 235 of the filter group 230 is preferably positioned on the wheelhouse 185 on which the air intake 180 is also positioned. In particular, the casing 235 can be positioned on the convex surface 195 of the arched strip of the wheelhouse 185, preferably at the top thereof and orientated horizontally.

In greater detail, in the embodiment illustrated herein the lower face of the casing 235 is resting on two profiled elements 275 realized in relief at the top of the convex surface 195 of the wheelhouse 185, to which it is fixed by screws 280.

It is however possible that in other embodiments (not illustrated), at least a portion of the casing 235, for example the box body without the cover 255, can be integrated in the wheelhouse 185, i.e. fashioned in a single body therewith.

In other embodiments (also not illustrated), the casing 235 might be realised in such a way as to exhibit the access openings 257 facing towards the wheel chamber and the cover 255 might be realised by an openable portion of the wheelhouse 185, for example a hatch, which can be opened or removed from the outside of the bodywork 105, i.e. from inside the wheelhouse.

Obviously a technical expert of the sector might make numerous modifications of a technical/applicational nature to the motor vehicle 100 as described above, without its forsaking the scope of the invention as claimed in the following.

1. A vehicle (100) comprising a bodywork (105), a wheelhouse (185) able to delimit a recessed chamber of the bodywork (105) containing a wheel of the wheels (145) of the vehicle (100), an internal combustion engine (140) and an aspirating conduit (175) able to convey air from an air intake (180) to the internal combustion engine, wherein the air intake (180) is positioned on the wheelhouse (185) of the bodywork in such a way as to make available at least an inlet opening (210) which opens, externally of the bodywork (105), in a zone internally of the wheelhouse (185).

2. The vehicle (100) of claim 1, wherein the inlet opening (210) opens in a zone at which aerodynamic effects due to motion of the vehicle (100) create an overpressure with respect to environmental atmospheric pressure.

3. The vehicle (100) of claim 1, wherein the air intake (180) is positioned adjacent to a concave internal surface (190) of the wheelhouse (185).

4. The vehicle (100) of claim 1, wherein the aspiration conduit (175) is intercepted by a filter group (230) positioned internally of the bodywork (105), which comprises a containing casing (235) provided with an inlet (240) connected to the air intake (180) and an outlet (245) connected to the internal combustion engine (140), and a filter cartridge (250) able to sub-divide the internal volume of the casing into a first chamber communicating with the inlet (240) and a second chamber communicating with the outlet (245).

5. The vehicle (100) of claim 4, wherein the filter cartridge (250) comprises a plurality of filter walls (260) having a tubular shape, which are configured so as to be crossed in parallel by the air to be filtered.

6. The vehicle (100) of claim 4, wherein the casing (235) of the filter group is fixed to the wheelhouse (185).

7. The vehicle (100) of claim 6, wherein at least a portion of the casing (235) of the filter group is integrated in the wheelhouse (185).

8. The vehicle (100) of claim 4, wherein the casing (235) of the filter group comprises an openable cover (255) for extraction of the filter cartridge (250).

9. The vehicle (100) of claim 8, wherein the cover is a removable portion of the wheelhouse (185).

10. The vehicle (100) of claim 1, wherein the air intake (180) comprises a tubular body (200) located at an end of the aspirating conduit (175), which is provided with at least an inlet opening (210) for air, and a hydrophobic net (215) fixed to the tubular body (200), which is able to intercept the inlet opening (210).

11. The vehicle (100) of claim 10, wherein the inlet opening (210) is positioned on the lateral wall of the tubular body (200) and in that the hydrophobic net (215) is conformed as a sleeve that is coaxially inserted on the tubular body (200).

12. The vehicle of claim 10, further comprising a helical body (222) inserted internally of the tubular body (200) downstream of the air inlet opening (210).
